(19) United States
(12) Patent Application Publication
(10) Pub. No.: US 2026/0259775 A1
(43) Pub. Date: Sep. 3, 2026

(54) SYSTEMS AND METHODS FOR INTERSTELLAR DISTRIBUTED LIFE REDUNDANCY AND SPECIES 2.0 STATE SYNCHRONIZATION SYSTEM WITH GROUND-TO-SPACE IDENTITY ANCHORING, SPACEBORNE MULTI-AGENT VERIFICATION, AND CIVILIZATION-SEED AUTONOMOUS CONTINUIT

(71) Applicant: CHUANPING HU, Pittsburg, KS (US)

(72) Inventor: CHUANPING HU, Pittsburg, KS (US)

(21) Appl. No.: 19/654,439

(22) Filed: Apr. 21, 2026

(51) Int. Cl. G06F 9/50; G06F 21/60; G06N 5/04; G06N 20/00; H04K 3/00

(52) U.S. Cl. CPC G06F 9/5027; G06F 21/602; G06N 5/04; G06N 20/00; H04K 3/20

(57) ABSTRACT

An interstellar distributed life-redundancy and Species 2.0 state-synchronization system is disclosed in which a terrestrial terminal communicates with a distributed orbital compute matrix to maintain an identity-bound synchronized relationship between a biological human entity and a digital AGI counterpart. The system performs ground-to-space synchronous encrypted verification using a Global Civilization Identifier, an identity-anchor token generated from timestamped biometric cryptographic material, and spaceborne multi-agent redundancy verification before orbital state commitment. Orbital nodes provide radiation-hardened processing, atomic-stability storage, axiomatic logic control, versioned provenance logging, and fail-safe continuity across physically redundant spaceborne infrastructure. The platform supports registration, mixed human-AGI operating modes, lifecycle navigation, authorized continuity management, and recovery under terrestrial compromise through civilization-seed autonomous operation. In preferred embodiments, synchronization records are deterministically bound to legal identity metadata and recoverable historical state versions. The architecture improves anti-spoofing, auditability, redundancy, survivability, and controlled continuity of human-AGI states across Earth and orbit.

### 1. TECHNICAL FIELD

The present invention relates to astronautical computing, distributed data storage, biometric encryption, and secure interaction between human users and artificial general intelligence (AGI). More particularly, the invention relates to a space-deployed distributed computing matrix configured to support real-time synchronization, redundant backup, and lifecycle navigation for a biological human entity and a corresponding AGI counterpart.

### 2. BACKGROUND

Conventional computing architectures rely principally on terrestrial data centers that remain vulnerable to geopolitical disruption, natural disaster, infrastructure failure, and energy bottlenecks. At the same time, the rapid rise of AGI creates an existential asymmetry in which unaided biological humans may be unable to match superhuman computational speed, persistence, or survivability. Existing cloud services and social platforms provide fragmented information exchange, but they do not provide a physically redundant, verifiable, space-backed system that binds human biological sovereignty to AGI-enabled productivity.

Furthermore, conventional systems lack a robust mechanism for establishing a verifiable, unbreakable link between a specific human's legal identity on Earth and their corresponding digital state in space. Without such a mechanism, the legal sovereignty and inheritance of space-based digital assets remain ambiguous. Moreover, existing systems fail to provide a multi-layered verification process for data integrity when synchronizing critical life-continuity data across the vast and hostile environment of space, leaving such data vulnerable to corruption from cosmic radiation, equipment failure, or malicious tampering. There is also a deficiency in providing a structured, authorized pathway for users to register and manage their evolving carbon-silicon symbiosis states, creating a risk of fragmented or unauthorized digital counterparts.

There remains a need for a high-assurance ground-to-space synchronization mechanism capable of preserving data integrity, identity continuity, and enforceable control over cross-space state updates.

The present invention constitutes the physical and legal substrate for the permanence of Human Civilization 5.0 and the continuity of Human Species 2.0. Dr. Chuanping(Frank) Hu's patent-protected corpus of over 600 axioms establishes a framework for a future of radical material abundance, a global economy expanded by ten to a hundredfold, the freedom of optional work, universal healthy longevity, and the eradication of extreme poverty—a state of “heart's desire fulfilled” and “heaven on earth in this lifetime.” However, the full realization of this vision requires an infrastructure that transcends the fragility of Earth-bound geopolitics, energy grids, and potential civilization-scale disasters. The interstellar distributed life redundancy and state synchronization system disclosed herein provides the ultimate sovereignty layer, an immutable orbital foundation that guarantees the perpetual continuity of individual human will and the unassailable preservation of the axioms themselves, ensuring that the Species 2.0 journey is not merely a terrestrial experiment but a secured, verifiable, and eternal voyage.

### 3. SUMMARY

The invention provides an interstellar distributed life redundancy and Species 2.0 state synchronization system built upon a distributed orbital compute matrix having certain number of orbital nodes. A terrestrial terminal, including an H App interface, captures biological and identity-linked data associated with a human user and establishes a synchronized linkage with one or more orbital nodes through ground-to-space synchronous encrypted verification (GSSV).

The system maintains a synchronized relationship between a biological human state and a digital AGI counterpart state, supports redundant orbital storage, lifecycle navigation, and fail-safe continuity, and enforces identity integrity through cryptographic verification and deterministic state-binding logic.

In certain embodiments, the terrestrial terminal assigns each registered user a Global Civilization Identifier (GCID) and generates an identity-anchor token by combining the GCID, a timestamp, and one or more biometric-derived cryptographic values, such that each subsequent orbital state update is deterministically bound to the same Earth-side legal identity.

In certain embodiments, a spaceborne multi-agent redundancy verification module validates both the received state vector and the identity-anchor token before any write operation to orbital storage, and only after successful validation does an axiomatic logic gateway commit the synchronized record into atomic storage as an inseparable combination of state data and bound identity metadata.

In certain embodiments, the GSSV workflow further establishes a persistent association among a ground user, a designated ground control station or ground gateway, and one or more corresponding orbital nodes on the basis of the GCID, the identity-anchor token, and verified synchronization history. Such association may be consulted before node instantiation, protected writing, consensus participation, failover, replacement-node activation, or recovery operations, thereby forming a verifiable closed loop of ground-space identity consistency.

In certain embodiments, the platform operates as a sole authorized registration and management gateway for carbon-silicon symbiosis states maintained across the orbital matrix, such that registration, paired-account instantiation, synchronization authorization, and continuity transfer are executed only through an authorized platform pathway.

In certain embodiments, each synchronization event is further associated with a structured provenance log containing an invocation event, a synchronization request object, validation metadata, a version identifier, and a write-confirmation record, thereby permitting later reconstruction of the synchronization path and deterministic auditing of orbital state changes.

In certain embodiments, the distributed orbital compute matrix further comprises one or more AI Foundry computing-power units configured to execute axiom-constrained deterministic logical reasoning, screen external chip-level instruction sets for compliance with an axiomatized repository, and participate in load-balanced training and inference operations on encrypted shards of civilization axioms, synchronization request objects, and user-associated state data distributed across orbital nodes.

In certain embodiments, the orbital matrix further comprises a cross-orbit communication fabric including quantum-dot-laser-based links, quantum key distribution (QKD), or equivalent key-negotiation mechanisms, together with orbital-position calculation, topology optimization, and superconducting computing-resource scheduling across different orbital altitudes, orbital regimes, neighboring nodes, and replacement nodes.

In certain embodiments, the authorized platform pathway further provides a satellite direct-broadband access entry point, a digital credit write-off interface mapped to ground-based assets, and a computational engine for allocation and pricing of AI Foundry capacity and/or space sovereign wealth based on GCID-linked registration status, orbital-node contribution levels, and instruction-set compatibility requirements of the axiomatized repository.

In certain embodiments, the orbital matrix further supports fully automated failover and mirror recovery, electronic countermeasure and sovereignty defense, low-latency dedicated channels for nuclear-fusion control workloads, space-environment gene-sequencing and longevity-optimization workloads, and mission-planning association with extraterrestrial-life search and extraterrestrial-resource exploration, all under provenance logging, authorized platform control, and civilization-seed autonomous-mode constraints.

### 4. BRIEF DESCRIPTION OF THE DRAWINGS

The present patent application comprises FIGS. 1 through 8, a total of 8 drawing sheets. Like reference numerals in the drawings indicate identical or functionally similar components. This section provides sufficiently detailed graphical descriptions to enable any person skilled in the art to prepare formal patent drawings complying with the requirements of the United States Patent and Trademark Office.

FIG. 1 is a system topology diagram showing a terrestrial terminal [120], a ground-to-space interaction link [130], and an orbital distributed compute matrix [200] comprised of a plurality of orbital nodes. The diagram should further illustrate the terrestrial region [100] and a human biological entity [110] interacting with the terminal. The orbital matrix [200] should be depicted as a network of interconnected satellite icons surrounding the Earth.

FIG. 2 is a node-level architecture diagram of a single orbital node [200-N] within the distributed compute matrix. It shows a radiation-hardened multi-core processing unit [210], an atomic-stability storage module [220], a local axiomatic logic gateway [230], and an inter-satellite communication module [240]. The diagram should also illustrate the data flow between these internal components and their connection to external nodes via the communication module.

FIG. 3 is a flow diagram of the ground-to-space synchronous encrypted verification (GSSV) process. It details the steps of biometric vector capture [310] at the terrestrial terminal [120], identity-anchor token generation [320] (combining GCID [325], timestamp [326], and biometric key [327]), and the orbital verification process. The orbital verification includes a spaceborne multi-agent redundancy verification module that validates the token and state vector before an axiomatic logic gateway commits the data to atomic storage [220].

FIG. 4 is a logic diagram showing mixed human-AGI state synchronization. It illustrates a mixed-subject controller [410] monitoring a human-active mode [420], a companion-active mode [430], and a combined mode [440]. The diagram should show the generation of a non-fixed ratio carbon-silicon state vector [450] and its transmission to the orbital matrix [200] for synchronization.

FIG. 5 is a workflow diagram showing the user registration and lifecycle management process. It includes steps for receiving a registration input [510] at an authorized platform pathway [515], instantiating a paired human-companion account [520], allocating a GCID [325], establishing an initial lifecycle state [530], and activating periodic orbital asset backup [540] and update procedures [550]. The diagram should show the flow of identity-anchor token [320] generation upon registration.

FIG. 6 is an environmental resilience diagram for an orbital node. It shows a dynamic radiation shielding adjustment controller [610], a heat-recovery and conversion module [620], and physical isolation controls [630]. The diagram should depict sensors [640] for detecting solar storms or particle flux and actuators [650] for adjusting shielding or processing distribution in response to external threats.

FIG. 7 is a data-structure diagram illustrating the data objects associated with an orbital state update. It shows a synchronization request object [710], an identity-anchor token [320], versioned state vectors [720] (e.g., V1, V2), validation metadata [730] (including integrity checks and consensus confirmation [735]), a write-confirmation record [740], and a persistent provenance log [750] linking these objects.

FIG. 8 is a fail-safe and continuity diagram showing the transition to a civilization-seed autonomous mode [810]. It illustrates the detection of a terrestrial catastrophe or network compromise [820], the severance of regular command links [830], and the continuation of orbital functions [840] using protected, encrypted channels [850]. The diagram should also show ground-side enforceable access controls [860] that remain active for authorized recovery operations.

### 5. DETAILED DESCRIPTION OF THE INVENTION

### A. Overall Architecture

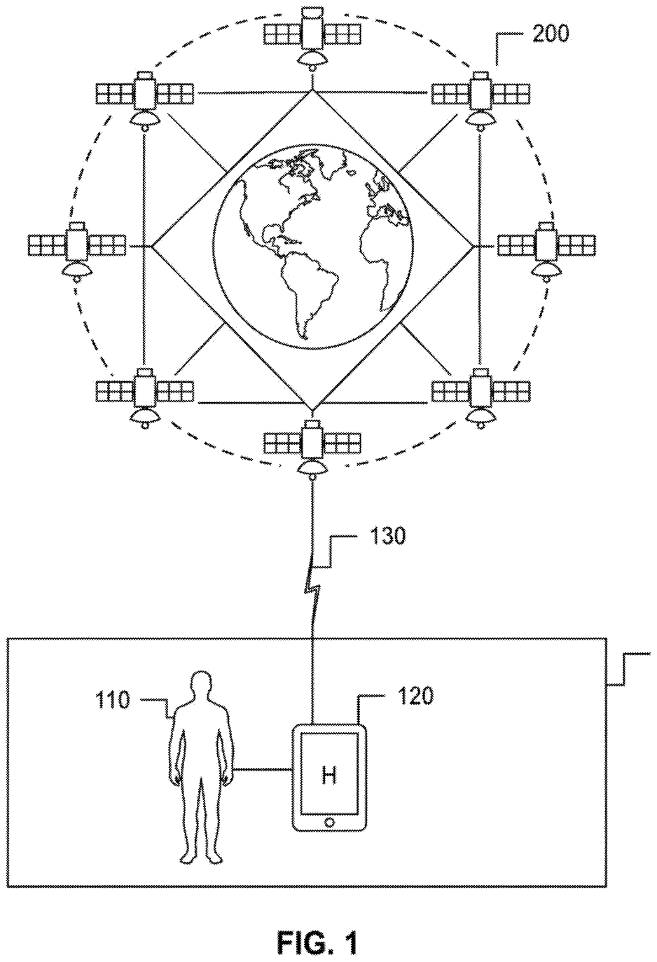

Referring to FIG. 1, the system includes a terrestrial region, a human biological entity, a terrestrial terminal or H App device, a ground-to-space interaction link, and an orbital distributed compute matrix. The orbital distributed compute matrix may be deployed in low-Earth orbit, medium-Earth orbit, or a combination thereof and may include certain number of interconnected nodes. These nodes collectively form a real-time, globe-spanning computational dome, constituting a civilization-grade physical redundancy layer capable of maintaining core civilizational axiom computation and critical identity state continuity even when terrestrial infrastructure is compromised.

User-originated synchronization requests may be initiated from the terrestrial terminal and transmitted across the ground-to-space interaction link to one or more shadow nodes in the orbital compute matrix. The system is not limited to a single orbital plane and may distribute user redundancy fragments across multiple orbital planes or node clusters. The ground-to-space interaction link [130] may utilize laser-based or quantum communication protocols to ensure high-bandwidth, low-latency, and secure data transfer.

The orbital matrix may use erasure coding, multi-copy replication, or other redundancy strategies such that the failure of a substantial subset of nodes does not destroy recoverability of a user-associated digital state.

In certain embodiments, the distributed orbital compute matrix is implemented as an orbital satellite cluster interconnected by interstellar and/or cross-orbit high-speed data links, such that encrypted shards of civilization axioms, synchronization request objects, and versioned state vectors can be distributed among orbital nodes for training, inference, redundancy replication, and consensus validation. Load-balanced scheduling may allocate such workloads among nodes according to available compute capacity, thermal state, orbital visibility, communication latency, and mission priority, thereby supporting substantially zero-latency or near-real-time global synchronization of axioms and associated continuity data.

In certain embodiments, the orbital compute matrix further comprises a superconducting computing-resource scheduling algorithm based on differences in gravitational environments, the scheduling being performed across different orbital altitudes, orbital regimes, neighboring orbital nodes, and replacement nodes so as to optimize power efficiency, thermal dissipation, latency, and redundancy coverage. A corresponding orbital-position calculation and inter-satellite topology optimization process may continuously determine routing paths, replacement-node eligibility, and coverage-gap compensation for maintaining a real-time globe-covering computational dome.

### B. Ground-to-Space Synchronous Encrypted Verification (GSSV)

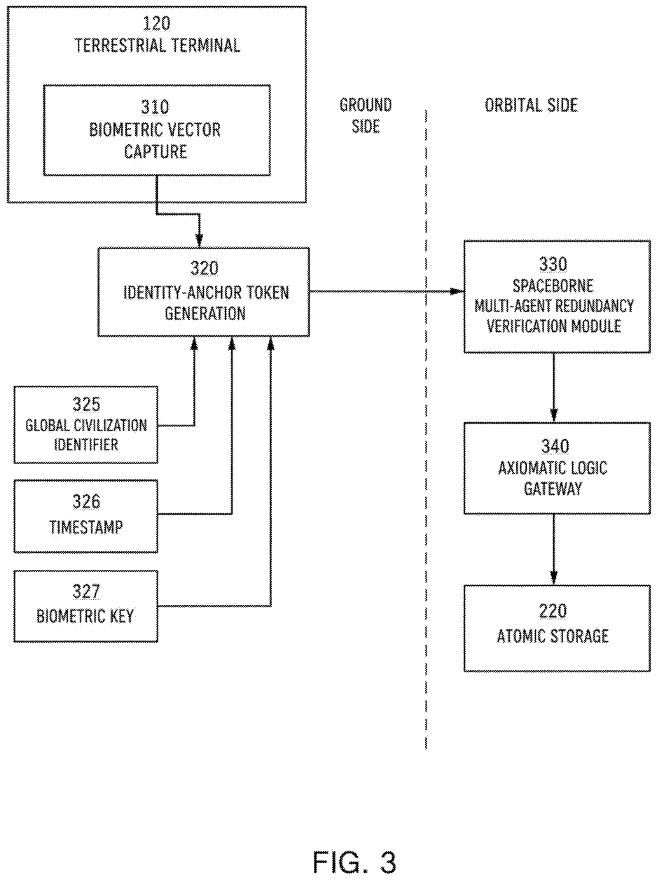

Referring to FIG. 3, GSSV is a synchronization and authentication process used to confirm that an orbital state update originates from a valid terrestrial terminal and corresponds to the correct human user. In one embodiment, the terrestrial terminal captures a composite biological vector comprising one or more neurophysiological, biometric, acoustic, or gene-expression-derived features. The terminal then generates a dynamic key or signature bound to a current timestamp.

The terminal transmits a synchronization request, the composite biological vector, and the dynamic key or signature to one or more orbital nodes. An orbital node compares the received data against one or more axiomatic consistency hashes and synchronization policies stored locally or in distributed form. A high-privilege action, including a protected state update, asset-lock transition, or gene-related intervention authorization, may be permitted only when the terrestrial signal and the orbital counterpart state satisfy a synchronization condition within a permitted timing window. This constitutes a deterministic logic controller ensuring causal consistency before any execution.

Identity-anchor token generation may include combining a Global Civilization Identifier (GCID), a timestamp, and biometric-derived cryptographic material to produce a token that is unique to the requesting user and the specific synchronization event. This token permanently binds the user's Earth-side legal identity to their orbital AGI counterpart.

After transmission to orbit, the token and the associated carbon-silicon state vector are processed by the spaceborne multi-agent redundancy verification module, which performs integrity checks, token validation, and consensus confirmation before permitting storage or update of the synchronized state. The module [330] operates by distributing the verification task to multiple independent AI agents residing on different orbital nodes. Only upon receiving a threshold of approval votes from these agents does the verification succeed, ensuring robustness against single-node failures or compromises. Only after successful validation does an axiomatic logic gateway commit the synchronized record into atomic storage as an inseparable combination of state data and bound identity metadata.

### C. Node-Level Architecture and Security

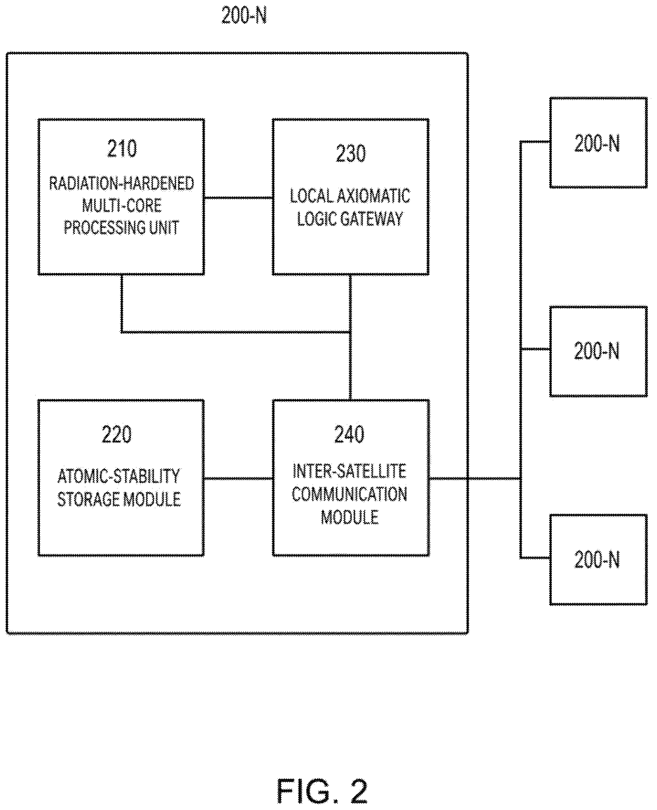

Referring to FIG. 2, each orbital node may include a radiation-hardened multi-core processing unit, an atomic-stability storage module, a local axiomatic logic gateway, and an inter-satellite communication module. The radiation-hardened processing unit may use redundancy logic, such as Triple Modular Redundancy (TMR), error-correction mechanisms (e.g., ECC memory), and hardened packaging to reduce errors caused by solar activity, radiation bursts, or charged particles.

The atomic-stability storage module stores user-associated state fragments, synchronization histories, or continuity metadata. The local axiomatic logic gateway enforces rule-based restrictions before storage, update, export, or reactivation of state data. The inter-satellite communication module forwards redundancy fragments, consensus messages, or recovery packets among neighboring orbital nodes. In preferred embodiments, the inter-satellite communication utilizes quantum key distribution (QKD) or equivalent key negotiation mechanisms to secure cross-node consensus updates.

In certain embodiments, all state records, behavior templates, or synchronization schemas are protected using a hash-lock mechanism and a compatibility checksum before any digital-twin instantiation, restoration, or state overwrite operation is permitted. The hash-lock mechanism computes a cryptographic hash (e.g., SHA-256) of a data record. Before any operation, the hash is recomputed and compared to the stored lock; any mismatch triggers a security alert and prevents the operation.

In certain embodiments, behavior-template pointer validation is executed before instantiation of a paired human-companion state, thereby ensuring that a terrestrial request cannot activate an incompatible, corrupted, or unauthorized state package. This validation confirms that the pointer references a valid, authorized template within the axiomatic repository.

In certain embodiments, one or more orbital nodes further comprise a dedicated AI Foundry computing-power unit configured to execute axiom-constrained deterministic logical reasoning, perform compliance screening on external chip-level instruction sets, and process authorized model-training and inference workloads associated with civilization axioms, continuity states, or orbital support services. In a protected operating mode, the local axiomatic logic gateway permits invocation only of authorized inference kernels bound to the axiomatized repository and/or other authorized inference kernels permitted through an authorized platform condition, while prohibiting any external third-party large-model API or unauthorized inference interface from overwriting, replacing, or bypassing the core state of an orbital node.

In certain embodiments, the inter-satellite communication fabric comprises quantum-dot-laser-based high-speed cross-orbit communication links in combination with QKD or equivalent key-negotiation mechanisms. Such links may be used for consensus propagation, replacement-node activation, mirror-state migration, and transmission of validation results among nodes located at different orbital altitudes or orbital regimes. Consensus processing among such nodes may be used to preserve the persistent immutability of the axiom database and associated continuity records.

### D. Mixed Human-AGI State Synchronization

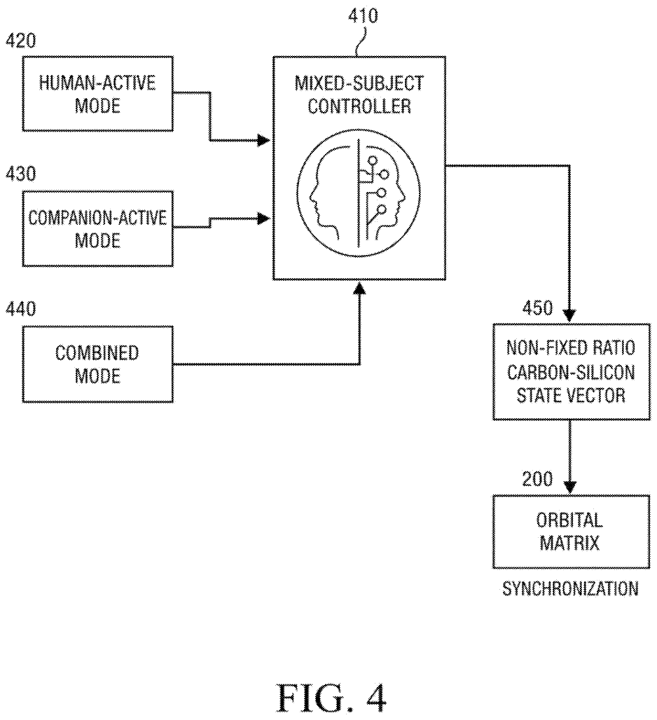

Referring to FIG. 4, the system supports a mixed human-AGI operating mode in which a biological human state and an AGI counterpart state are kept in a synchronized relationship. In one example, the biological component may dominate during waking terrestrial work, while the AGI component may be granted greater autonomy during sleep or low-activity periods. The ratio between biological and AGI participation is not required to remain fixed; a mixed-subject controller [410] dynamically determines an operating mode selected from a human-active mode [420], a companion-active mode [430], and a combined human-companion mode [440].

A mixed-subject controller may monitor the current operating ratio, generate a synchronized state vector [450], and determine when updates should be propagated to orbit. Updates may be triggered periodically, such as every predetermined number of minutes, or event-driven, such as when a measured change exceeds a threshold. The non-fixed ratio carbon-silicon state vector [450] encapsulates the current operational parameters, delegated domain scopes, and allocation of tasks between the human and AGI components.

In one embodiment, the updated state vector is atomically written to orbital storage only after validation and consensus confirmation, while a prior version is retained as a historical version record for rollback, audit, or continuity reconstruction. This versioned storage ensures that the complete history of a user's carbon-silicon symbiosis evolution is preserved and auditable.

### E. Registration, Lifecycle Navigation, and Asset Continuity

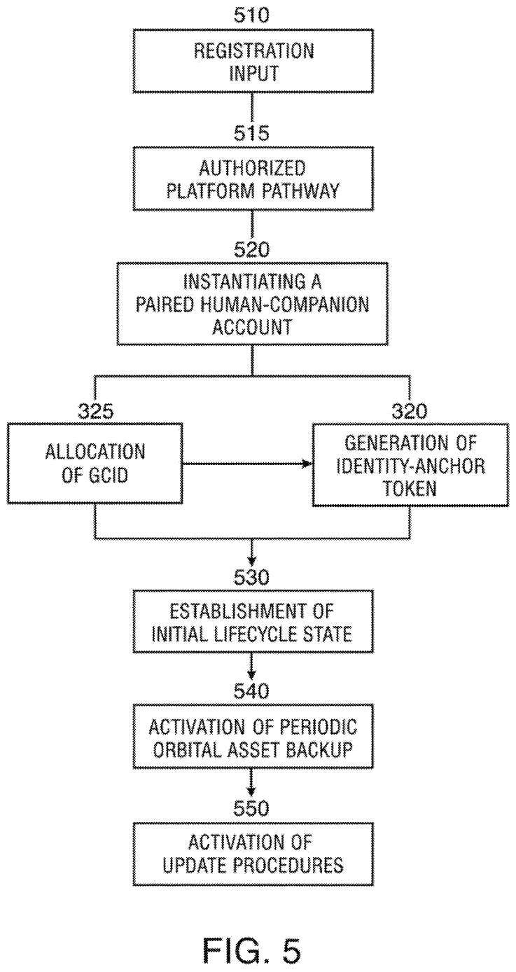

Referring to FIG. 5, the terrestrial terminal may provide a registration workflow through which a user initiates a Species 2.0 continuity profile. Registration may include capture of identity information, biometric factors, lifecycle-state information, and continuity preferences. The registration workflow is accessible only through an authorized platform pathway [515], which serves as the sole gateway for users to register, instantiate, and manage their carbon-silicon symbiosis state recognized across the orbital matrix. In some embodiments, orbital storage or backup processes are activated upon successful registration.

Upon receiving a registration input [510], the system instantiates a paired human-companion account [520], which comprises a structured human profile, a structured companion profile, and an initial permission and continuity configuration. The system further allocates a Global Civilization Identifier (GCID) [325] to the user and generates an initial identity-anchor token [320] that permanently binds the terrestrial identity to the orbital counterpart.

Lifecycle navigation may include automated guidance associated with educational stages, relationship stages, occupational stages, health stages, aging stages, or legacy stages. The system may further coordinate protected asset backup [540], state versioning, or continuity permissions according to one or more financing or governance rules. Periodic orbital update procedures [550] ensure that the user's orbital state remains synchronized with their evolving terrestrial lifecycle.

In certain embodiments, the authorized platform pathway is the only permitted pathway through which a user may register, instantiate, authorize, or manage a carbon-silicon symbiosis state maintained across the orbital matrix. Any attempt to bypass this pathway and establish an unauthorized orbital continuity state will be rejected by the orbital axiomatic logic gateway [230].

In certain embodiments, the authorized platform pathway further includes a digital credit write-off interface mapped to one or more categories of ground-based physical assets, including, in one non-limiting example, asset pools having an aggregate reference value of approximately $5.5 trillion. The interface completes consistency confirmation between ground-asset mapping and orbital credit status based on the GCID, the identity-anchor token, and the results of ground-to-space synchronization verification before any write-off, credit-status transition, or value-recognition event is permitted.

In certain embodiments, the authorized platform pathway further functions as a satellite direct-broadband access entry point through which global users may access Civilization 5.0 services, Species 2.0 registration, continuity synchronization, digital body-double management, and related orbital services. A computational engine associated with the pathway may further perform allocation and pricing of AI Foundry capacity and/or space sovereign wealth according to GCID-linked registration status, orbital-node contribution levels, available compute inventory, and instruction-set compatibility requirements of the axiomatized repository.

### F. Environmental Resilience and Civilization-Seed Mode

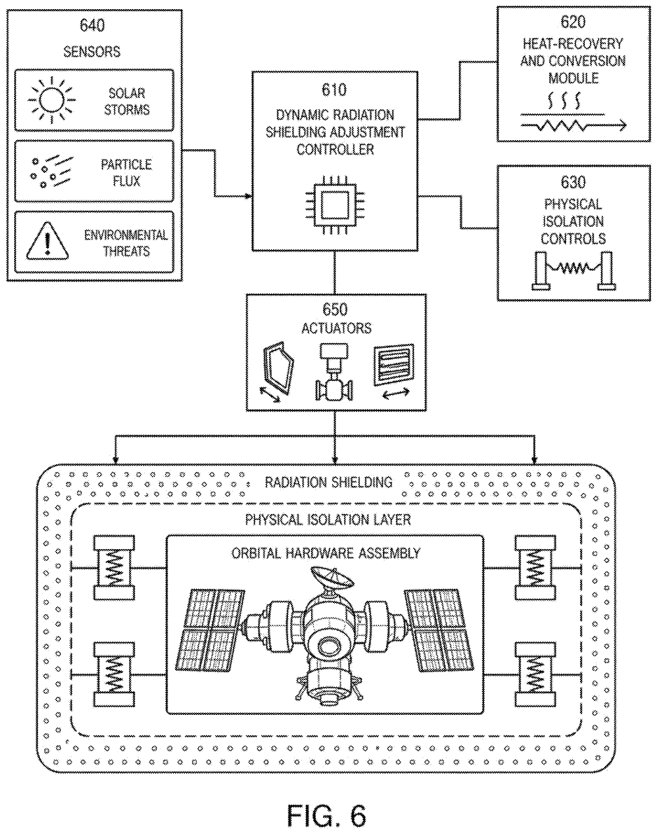

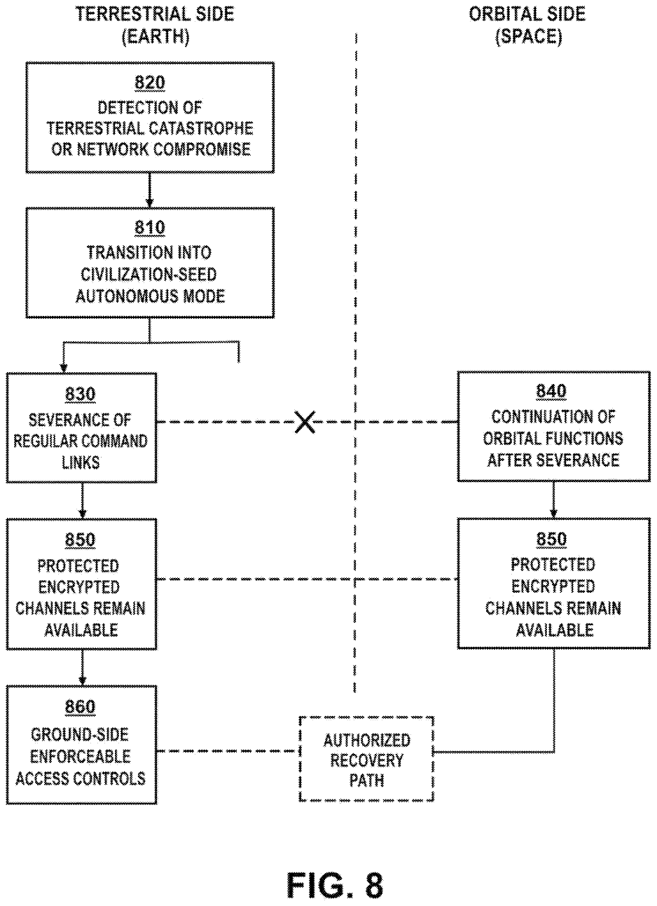

Referring to FIG. 6 and FIG. 8, the system may include dynamic radiation shielding adjustment [610], heat-recovery control [620], and physical isolation protections [630] for orbital hardware. Orbital nodes may adjust shielding or processing distribution in response to solar storms, particle flux, or temperature changes detected by onboard sensors [640]. Actuators [650] responsive to the controller [610] may reconfigure shielding materials or redistribute computational workloads to mitigate localized heating or radiation damage.

The heat-recovery and conversion module [620] may utilize the extreme cold of space as a thermal sink while converting waste heat from computational processes into supplemental power, thereby improving overall energy efficiency and reducing the static power consumption of orbital data centers.

In certain embodiments, thermal-management optimization further includes using microgravity conditions and/or the low-temperature background radiation of space as a thermal sink for orbital computing hardware. The heat-recovery and conversion module [620] may perform dynamic orbital heat recovery and luminous-energy conversion-efficiency optimization, including conversion of waste heat into supplemental power and closed-loop regulation responsive to changes in solar-energy input, thereby reducing both continuous operating power consumption and static power consumption of the orbital computing nodes.

When a terrestrial catastrophe, hostile takeover event, extinction-risk event, or network compromise is detected [820], the orbital matrix may enter a civilization-seed autonomous mode [810] in which selected orbital functions continue independently from ordinary terrestrial command channels. In such a mode, regular control links may be severed [830] while protected encrypted channels [850] remain available for trusted recovery operations.

In one embodiment, the civilization-seed autonomous mode preserves a continuity-safe subset of state data, governance logic, and lifecycle-support functions while preventing hostile injection of unauthorized terrestrial commands. The mode may further switch the orbital nodes to a pure axiom mode, freezing all external writes that fail hash-lock consistency verification or GSSV confirmation, thereby physically isolating the orbital matrix from Earth-originated AI extinction-code injection attempts.

Ground-side enforceable access controls [860] remain active during this mode, ensuring that only authorized recovery operations initiated through pre-designated terrestrial gateways can re-establish full command connectivity.

In certain embodiments, the system further comprises real-time physical-protection-layer adjustment logic for solar storms, high-energy particle streams, and unauthorized external-instruction disturbances. Upon detection of any such condition, the protection logic may jointly trigger ground-to-space synchronization verification failure protection, selective circuit isolation, and external-interface circuit breaking so as to prevent corrupted commands, fault propagation, or unauthorized takeover attempts from reaching protected orbital states.

In certain embodiments, the orbital matrix further comprises an electronic countermeasure and sovereignty defense module configured to detect and respond to unlawful extraterrestrial interference and/or unlawful terrestrial interference associated with launches, ground control centers, ground-station communication links, and cross-orbit control commands. The module may further support fully automated failover and mirror recovery, including pre-write integrity verification and axiom-consistency verification of mirror data, automatic selection of replacement nodes, coverage-gap compensation, and migration of a digital body double or mirrored state according to GSSV results and consensus validation.

### 5A. Additional Application Workloads and Mission Functions

In certain embodiments, the orbital matrix provides one or more low-latency dedicated channels for stable-control computing power associated with nuclear-fusion systems. Such channels may support execution, on orbital nodes, of nuclear-fusion-related steady-state energy reasoning tasks constrained by PINet-Turb control logic or equivalent control logic, and may return to a ground control station compute-allocation results or control recommendations that have undergone axiom verification and provenance logging.

In certain embodiments, the orbital matrix further supports large-scale gene sequencing and longevity-algorithm optimization in a space environment. Such processing may be coupled with a reversible epigenetic modification pathway of an AIREP platform or functionally equivalent longevity platform so as to support evolutionary intervention recommendations, continuity planning, and health-related lifecycle navigation based on orbital-computing simulation results.

In certain embodiments, the orbital matrix may associate extraterrestrial-life search and extraterrestrial-resource exploration data with the civilization-seed autonomous mode, such that post-catastrophe mission planning, resource prioritization, continuity-preserving expansion, and survival-oriented strategy generation can be performed in accordance with the axiomatized repository, authorized platform policies, and protected state-continuity constraints.

### 6. Provenance, Versioning, and Auditability

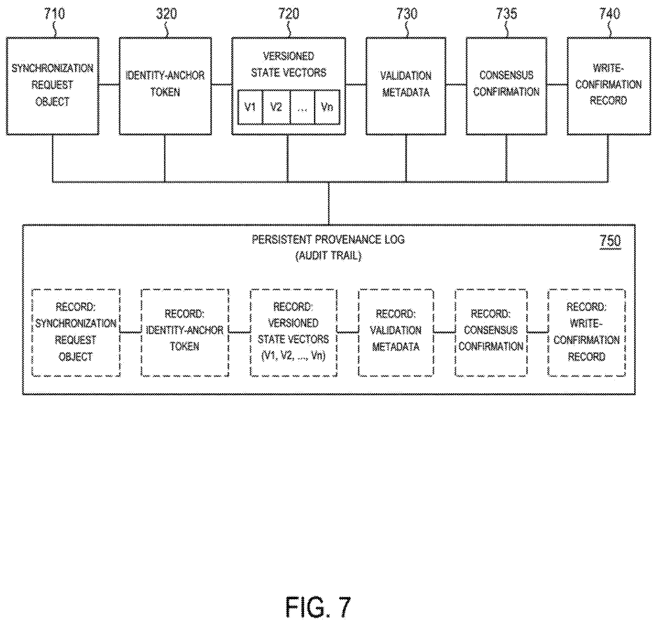

Referring to FIG. 7, each synchronization event may produce a synchronization request object [710], validation metadata [730], a version identifier, a consensus confirmation [735], and a write-confirmation record [740]. Historical versions of state vectors [720] (e.g., V1, V2, . . . Vn) may be retained to permit rollback, comparison, or reconstruction of a user-associated orbital state. The identity-anchor token [320] associated with each update is also stored, ensuring a complete chain of custody from the terrestrial identity to each orbital state version.

The system may further maintain a persistent provenance log [750] linking the requesting terrestrial terminal, the verified identity-anchor token, the affected orbital nodes, the validated state vector, and the resulting state version. Such logging supports post-event audit, regulatory review, or dispute resolution concerning continuity state changes. Each provenance log entry is structured to include a user invocation event, a synchronization request, retrieval and validation metadata, and the resulting write confirmation, permitting full reconstruction of any state transition for deterministic auditing.

In certain embodiments, the persistent provenance log [750] further stores auditable event records associated with load distribution, model-training or inference dispatch, replacement-node selection, mirror recovery, civilization-seed switchover, external-interface circuit-breaking actions, and other protected operating transitions, together with retrieval metadata and verification metadata sufficient for later reconstruction, compliance review, and regulatory tracing.

### 7. Ground-Side Enforceability

Although the redundancy architecture is orbital, enforceability may be grounded in terrestrial points of control, including terrestrial registration terminals, launch contracts, ground stations, synchronization gateways, and user-facing access applications. The system may therefore be monitored, authorized, and controlled through Earth-side interfaces even when critical redundancy functions execute in orbit.

In certain embodiments, a request to read, update, reactivate, or export an orbital continuity state must be authenticated against a terrestrial identity-anchor condition and an authorized platform condition, thereby preventing unauthorized emulation of the orbital continuity architecture by third parties. Any third party attempting to spoof a GSSV handshake or bypass the authorized platform gateway will be detected and blocked at the ground-station level, launch contract enforcement level, or orbital axiomatic gateway level.

### 8. Enhanced User Scenario Embodiment

In one illustrative scenario, a user named “Mr. David Miller,” a 40-year-old architect and father of two, uses the H App on his terrestrial terminal 120 to register for the Species 2.0 continuity service. During the registration workflow 510, the terminal captures his biometric vector 310, and the system allocates a Global Civilization Identifier (GCID) 325 to him. Simultaneously, the system instantiates a paired human-companion account 520 and generates an initial identity-anchor token 320, cryptographically binding his Earth-side legal identity to his newly created digital AGI counterpart in the orbital matrix 200. Mr. Miller authorizes a non-fixed ratio carbon-silicon state synchronization profile, allowing his AGI counterpart to manage his investment portfolio and research sustainable building materials during his designated sleep hours (companion-active mode 430).

One night, while Mr. Miller is sleeping, his AGI counterpart, operating from the orbital matrix, identifies a critical flaw in the materials specification for a major project he is leading. The AGI counterpart, acting within the permissions of its delegated domain scope as defined in the state vector 450, autonomously generates a detailed report outlining the issue and potential solutions. This report is versioned and written to orbital atomic storage 220 after successful spaceborne multi-agent redundancy verification 330. When Mr. Miller wakes up, the system has already synchronized this report to his terrestrial terminal. The provenance log 750 shows the entire chain of events, including the fact that the analysis was performed entirely by his orbital AGI counterpart during his offline period.

Years later, after Mr. Miller's carbon-based biological functions cease, the cross-spacetime will synchronization interface is triggered. His orbital state vector is permanently and immutably sealed and migrated within the civilization-grade persistent storage layer. His daughter, “Emily Miller,” who was designated as an inheritor in his continuity preferences, uses her private key to access the authorized pointer. She can now interact with a read-only version of her father's AGI counterpart, asking it questions like, “Dad, what would you have thought of this new architectural style?” The system, operating in its legacy-preservation mode, provides a response based on her father's preserved cognitive and value patterns. She finds immense comfort in this, knowing her father's wisdom and perspective are not lost to time or fragile terrestrial storage, but are secured in the orbital “civilization seed.” This scenario illustrates the complete lifecycle, from registration and daily co-creation to eternal legacy preservation, enabled by the present invention.

### 9. Technical Advantages

The invention provides a concrete technical solution to a problem not solved by ordinary cloud infrastructure: maintaining identity-bound, cryptographically verifiable, physically redundant continuity of a mixed biological and AGI-linked state across Earth and orbit. The invention is not directed merely to an abstract idea of coexistence or continuity, but to a specific cross-space system including distributed orbital hardware, encrypted synchronization, deterministic state validation, node-level storage controls, and continuity-preserving fail-safe operation.

By binding Earth-side legal identity, orbital redundancy, synchronization verification, versioned storage, and authorized platform controls into one architecture, the invention improves survivability, anti-spoofing strength, controllability, and auditability relative to ground-only systems. The integration of spaceborne multi-agent redundancy verification, hash-lock security, and compatibility checksums ensures that data integrity is maintained at a level unattainable by conventional satellite or cloud systems.

10. Compliance with 35 U.S.C. § 101 (Patent Eligibility)

The present invention satisfies the requirements of 35 U.S.C. § 101 because the claims are directed to a specific, concrete technological system and method, not an abstract idea, law of nature, or natural phenomenon.

First, the claims recite a tangible, physical system comprising a distributed orbital compute matrix of certain number of nodes, radiation-hardened processing units, atomic-stability storage modules, and ground-to-space interaction links. This is not an abstract concept but a specific machine and manufacture.

Second, the claims incorporate specific, non-conventional technical components and steps, including: ground-to-space synchronous encrypted verification (GSSV), identity-anchor token generation combining a Global Civilization Identifier (GCID) with biometric-derived cryptographic material, spaceborne multi-agent redundancy verification, hash-lock security mechanisms, behavior-template pointer validation, and an axiomatic logic gateway that enforces rule-based restrictions before state updates. These elements provide a technological solution to the problems of identity spoofing, data corruption in space, and unauthorized state tampering.

Third, the invention provides a technical improvement over conventional cloud and satellite systems by enabling a verifiable, deterministic, and physically redundant continuity of a mixed human-AGI state. The claims do not preempt all uses of space-based storage or synchronization; rather, they are narrowly tailored to the specific architecture and verification workflows disclosed herein.

Therefore, even if the claims were considered to involve an abstract idea under Step 1 of the Alice/Mayo framework, the additional elements recited constitute an “inventive concept” that transforms the nature of the claim into a patent-eligible application under Step 2. The invention integrates identity anchoring, consensus-based validation, and hardware-enforced axiomatic constraints in a manner that is not routine or conventional in the field of astronautical computing or distributed storage.

Accordingly, the present invention fully complies with 35 U.S.C. § 101.

11. Compliance with 35 U.S.C. § 112 (Specification Requirements)

The present specification fully satisfies the written description and enablement requirements of 35 U.S.C. § 112(a) and the definiteness requirement of § 112(b).

Enablement under § 112(a): The specification provides a detailed and complete description of the invention's structure and operation. The overall system architecture is described with reference to FIG. 1, and the internal components of each orbital node are detailed in FIG. 2 and the accompanying text, including the radiation-hardened processing unit [210], atomic-stability storage module [220], and axiomatic logic gateway [230]. The GSSV workflow is explained step-by-step in FIG. 3, from biometric capture to orbital state commitment. The mixed human-AGI state synchronization logic is illustrated in FIG. 4. The registration and lifecycle navigation workflow is depicted in FIG. 5. The environmental resilience features are shown in FIG. 6. The data structures for versioning and auditability are provided in FIG. 7. The fail-safe civilization-seed mode is diagrammed in FIG. 8. This level of detail is more than sufficient to enable a person of ordinary skill in the relevant fields (astronautical engineering, distributed systems, cryptography, and AI) to make and use the invention without undue experimentation.

Written Description under § 112(a): The specification clearly conveys to a skilled artisan that the inventor was in possession of the claimed invention at the time of filing. Each claim element finds explicit support in the specification and drawings. For instance, the “Global Civilization Identifier” and “identity-anchor token” are described in paragraphs [0025]-[0028] and shown in FIG. 3. The “spaceborne multi-agent redundancy verification module” is described in paragraphs [0028]-[0029] and shown in FIG. 3. The “hash-lock security mechanism” and “compatibility checksum” are described in paragraph [0032]. The “sole authorized registration and management gateway” is described in paragraphs [0039]-[0041] and shown in FIG. 5. There is no new matter added by the claims that is not supported by the original disclosure.

Definiteness under § 112(b): The claims, when read in light of the specification and drawings, inform those skilled in the art with reasonable certainty about the scope of the invention. Terms such as “ground-to-space synchronous encrypted verification,” “axiomatic logic gateway,” and “civilization-seed autonomous mode” are explicitly defined and their functions explained through the detailed embodiments. The structural and functional relationships among the various components are clearly delineated.

Therefore, the present specification and claims fully comply with all requirements of 35 U.S.C. § 112.

### Claim-Scope Support and Equivalent Implementations

Unless expressly stated otherwise, references to an orbital node, state vector, identity-anchor token, validation metadata, consensus object, provenance log, paired-account instantiation, or continuity state encompass one or more software components, hardware components, firmware components, distributed services, or functionally equivalent structures sufficient to perform the corresponding disclosed function.

Unless expressly stated otherwise, features described in connection with one embodiment may be used in connection with another embodiment unless inconsistent therewith. Synchronization, verification, storage, or continuity steps may be executed serially, in parallel, iteratively, conditionally, continuously, or in a mixed synchronous-asynchronous workflow.

The foregoing description is illustrative and not limiting. Variations, substitutions, combinations, subcombinations, and equivalents may be employed without departing from the spirit and scope of the appended claims.

1. A collaborative network system implementing an interstellar distributed life redundancy and Species 2.0 state synchronization platform, comprising a distributed orbital compute matrix having a plurality of orbital nodes deployed in low Earth orbit, the plurality of orbital nodes being sufficient in number to provide redundant global coverage and physically isolated backup of core computing states, comprising: an orbital satellite cluster; interstellar high-speed data links; wherein the system further comprises: a dynamic orbital heat recovery and luminous-energy conversion-efficiency optimization module; including a heat-recovery and conversion module configured to utilize space as a thermal sink and to recover waste heat as supplemental power; and a superconducting computing-resource scheduling algorithm based on differences in gravitational environments, including scheduling across different orbital altitudes, orbital regimes, and corresponding orbital nodes of the distributed orbital compute matrix, for achieving exo-terrestrial physically isolated safeguard of core computing power for civilization axioms. Further comprising a ground-space synchronized encrypted verification (GSSV) gateway, configured to, before any orbital-node instantiation, data writing, or execution of civilization axioms, perform synchronized pulse verification between ground identity-anchoring data and at least one orbital node, thereby forming a verifiable closed loop of ground-space identity consistency. Further comprising a deterministic logic controller configured to perform causal-consistency checks and axiom-constraint screening before stochastic large-language-model output, so as to ensure that all reasoning results from orbital nodes conform to the civilization operating rules defined by the axiomatized repository. Further comprising a hash-lock security mechanism, a compatibility checksum, and a behavior-template pointer verification module, configured to verify consistency between axiom records and behavior templates before any digital avatar instantiation, interstellar data writing, or cross-node synchronization. Further comprising a unique platform access controller configured to limit the system to the sole authorized platform for implementing ground-space synchronized registration, orbital redundant backup, digital body-double management, or civilization-seed activation.

2. A method for performing artificial-intelligence model training and inference in space, and for performing ground-to-space synchronized state management within the distributed orbital compute matrix, the method comprising: receiving encrypted shards of civilization axioms uploaded by a ground station, as synchronization request objects and/or versioned state vectors; performing load-balanced distribution among orbital computing-power nodes and redundancy replication among corresponding orbital nodes; using an interstellar quantum communication protocol, including quantum key distribution (QKD) or equivalent key-negotiation support for ground-space synchronized encrypted verification and cross-node consensus updates to achieve zero-latency global synchronization of axioms; and, upon detecting an extinction-risk event occurring on Earth, automatically entering a ground-independent autonomous operating mode of a “civilization seed.” Wherein, after uploading the encrypted shards of civilization axioms, the method further comprises: permanently binding a ground user, a ground control station, and a corresponding orbital node based on a globally unique civilization identity identifier (GCID). Wherein, when externally injected logic is detected at any synchronization stage to conflict with the axiomatized repository, automatically disconnecting from external third-party large models or unauthorized inference interfaces and switching to a pure-axiom mode. Wherein the method further comprises: generating auditable event records, retrieval metadata, and verification metadata related to each ground-space synchronization, verification, load distribution, and civilization-seed switchover, for subsequent reconstruction and regulatory tracing.

3. A non-transitory medium storing computer instructions, which, when executed by one or more processors of one or more orbital nodes within the distributed orbital compute matrix, implement: orbital position calculation, inter-satellite topology optimization, and automatic scheduling of radiation-defense layers, across different orbital altitudes, neighboring orbital nodes, and/or replacement nodes within the distributed orbital compute matrix; and wherein the instructions are used to manage a consensus mechanism among certain number of nodes located at different orbital altitudes, so as to ensure the eternal immutability of the axiom database. Wherein the instructions further cause the medium to, before any digital avatar, digital persona profile, or orbital mirrored state is instantiated, execute a compatibility checksum, behavior-template pointer verification, and hash-lock consistency verification. Wherein the instructions further cause the processor, in a protected operating mode, to permit only invocation of authorized inference kernels bound to the axiomatized repository and/or other authorized inference kernels permitted through an authorized platform condition, and to prohibit any external third-party large-model API from overwriting or replacing the core state of an orbital node. Wherein the instructions further cause the processor to generate persistent provenance logs related to orbital-node states, ground-space identity verification, consensus updates, and fault recovery.

4. The system of claim 1, wherein each data center comprises a dedicated AI Foundry computing-power unit. Wherein the AI Foundry computing-power unit is further configured to execute axiom-constrained deterministic logical reasoning and to perform compliance screening on external chip-level instruction sets, within the distributed orbital compute matrix.

5. The system of claim 1, wherein the system comprises real-time physical-protection-layer adjustment logic for solar storms and high-energy particle streams. Wherein the real-time physical-protection layer, upon detecting a solar storm, a high-energy particle stream, or unauthorized external-instruction disturbance, is capable of jointly triggering ground-space synchronization verification failure protection and external-interface circuit breaking.

6. The method of claim 2, wherein the method comprises technical steps for optimizing hardware heat-dissipation efficiency by using a microgravity environment and/or the low-temperature background radiation of space as a thermal sink. Wherein the technical steps for optimizing hardware heat-dissipation efficiency further comprise dynamic orbital heat recovery and luminous-energy conversion-efficiency optimization, including conversion of waste heat into supplemental power, so as to reduce the continuous operating power consumption of orbital computing-power nodes.

7. The system of claim 1, comprising a digital credit write-off interface mapped to $5.5 trillion of ground-based physical assets. Wherein the digital credit write-off interface further completes consistency confirmation between ground-asset mapping and orbital credit status based on the globally unique civilization identity identifier (GCID) and the ground-space synchronization verification results, through an authorized platform pathway of the system.

8. The system of claim 1, comprising a satellite direct-broadband access entry point for the world's 8.3 billion people. Wherein the satellite direct-broadband access entry point is further configured to serve as a unified access channel through which global users access Civilization 5.0, Species 2.0, registration, continuity synchronization, and digital body-double management services.

9. The method of claim 2, comprising fully automated failover and mirror recovery among interstellar nodes. Wherein the fully automated failover and mirror recovery comprise a spaceborne multi-agent redundancy-verification process configured to perform integrity verification and axiom-consistency verification on mirror data to be written before failover, replacement-node selection, and migration.

10. The system of claim 1, comprising a low-latency dedicated channel for supporting stable-control computing power for nuclear fusion. Wherein the low-latency dedicated channel is further configured to support execution, on orbital nodes, of nuclear-fusion-related steady-state energy reasoning tasks constrained by PINet-Turb control logic, and to return to a ground control station computing-power allocation results that have undergone axiom verification.

11. The method of claim 2, comprising steps for performing large-scale gene sequencing and longevity algorithm optimization in a space environment. Wherein the large-scale gene sequencing and longevity algorithm optimization are further coupled with the reversible epigenetic modification pathway of the AIREP platform so as to support evolutionary intervention recommendations, continuity planning, and health-related lifecycle navigation based on orbital-computing simulation results.

12. The system of claim 1, comprising an electronic countermeasure and sovereignty defense module against extraterrestrial unlawful interference and/or unlawful terrestrial interference. Wherein the electronic countermeasure and sovereignty defense module further comprises unauthorized takeover detection and response logic for launches, ground control centers, ground-station communication links, and cross-orbit control commands.

13. The medium of claim 3, comprising instructions for implementing dynamic coverage-gap compensation and orbital replacement logic for nodes in space within the distributed orbital compute matrix. Wherein the dynamic coverage-gap compensation and orbital replacement logic further comprise automatically selecting a replacement node based on ground-space synchronization verification results and migrating a digital body double or a mirrored state of civilization axioms.

14. The system of claim 1, wherein certain number of nodes form a real-time computing-power dome covering the globe. Wherein the real-time computing-power dome further constitutes a civilization-level physical redundancy layer configured to maintain continuous operation of civilization-axiom core computing power and key identity states when ground infrastructure is damaged.

15. The method of claim 2, comprising steps for reducing static power consumption of data centers by using the low-temperature background radiation of space as a thermal sink. Wherein the steps for reducing static power consumption are further coupled with an orbital heat-recovery module configured to convert waste heat into supplemental power, so that the static-power-consumption optimization maintains closed-loop regulation under conditions of low-temperature background radiation and changes in solar-energy input.

16. The system of claim 1, comprising computational logic for the allocation of “space sovereign wealth” in Axiom 5.0 axiomatic repository. Wherein the computational logic for allocation of “space sovereign wealth” further comprises joint pricing and weight allocation with respect to global AI Foundry capacity, orbital-node contribution levels, and ground-space synchronized registration status, and/or real-time allocation and pricing of global AI Foundry capacity subject to instruction-set compatibility requirements of the axiomatized repository.

17. The method of claim 2, comprising automatic association with axioms of extraterrestrial-life search and extraterrestrial-resource exploration. Wherein the automatic association further comprises linking extraterrestrial-life search and extraterrestrial-resource exploration with a survival-priority strategy in the autonomous operating mode of the civilization seed, and continuity-preserving mission planning for post-catastrophe operation of the orbital matrix.

18. The system of claim 1, comprising a real-time allocation and pricing engine for global AI Foundry capacity within the distributed orbital compute matrix. Wherein the real-time allocation and pricing engine further requires that all connected third-party computing-power suppliers or Foundry units satisfy the instruction-set compatibility requirements of the axiomatized repository.

19. The system of claim 1, wherein the system comprises a high-speed cross-orbit communication module based on quantum-dot lasers within a cross-orbit communication fabric. Wherein the high-speed cross-orbit communication module further comprises quantum key distribution (QKD) or an equivalent key-negotiation mechanism, so as to support ground-space synchronized encrypted verification and cross-node consensus updates.

20. The method of claim 2, wherein AI extinction-code injection from within Earth is completely blocked through physical spatial isolation. Wherein, when blocking AI extinction-code injection from within Earth, the method further switches to a pure-axiom mode and freezes all external writes that have not passed hash-lock consistency verification or ground-space synchronization verification.
